(19) United States
(12) Patent Application Publication
(10) Pub. No.: US 2026/0145313 A1
(43) Pub. Date: May 28, 2026

(54) POWER TOOL ADAPTOR WITH ADDITIONAL FUNCTIONALITY

(71) Applicant: Milwaukee Electric Tool Corporation, Brookfield, WI (US)

(72) Inventors: Dapeng Zhao, Franksville, WI (US); Alexander Yu, Alpharetta, GA (US)

(21) Appl. No.: 19/398,879

(22) Filed: Nov. 24, 2025

Related U.S. Application Data
(60) Provisional application No. 63/725,341, filed on Nov. 26, 2024.

(51) Int. Cl. B25F 3/00

(52) U.S. Cl. CPC B25F 3/00

(57) ABSTRACT

Power tool adapters and methods for a power tool device to provide additional functionality. An adapter includes an adapter housing, a tool interface supported by the adapter housing and configured to couple to a first power tool device, and a pack interface supported by the adapter housing and configured to couple to a power tool battery pack. The adapter further includes one or more sensors to generate sensor data including an electrical characteristic of the power tool battery pack. An electronic controller is supported by the adapter housing and coupled to the tool interface, the pack interface, and the one or more sensors. The electronic controller receives the sensor data from the one or more sensors, detects, based on the sensor data, an auto-stop condition, and controls the power tool to cease operation in response to detecting the auto-stop condition.

### CROSS-REFERENCE TO RELATED APPLICATIONS

This invention claims priority to U.S. Provisional Patent Application Ser. No. 63/725,341, filed Nov. 26, 2024, the content of which is hereby incorporated by reference in its entirety.

### SUMMARY

Some embodiments of the disclosure provide an adapter for a power tool. The adapter includes an adapter housing; a tool interface supported by the adapter housing and configured to couple to a first power tool device; a pack interface supported by the adapter housing and configured to couple to a power tool battery pack, the pack interface being in electrical communication with the first interface; one or more sensors to generate sensor data, the sensor data including an electrical characteristic of the power tool battery pack; and an electronic controller supported by the adapter housing and coupled to the tool interface, the pack interface, and the one or more sensors, the electronic controller configured to: receive the sensor data from the one or more sensors, detect, based on the sensor data, an auto-stop condition, and control the power tool to cease operation in response to detecting the auto-stop condition.

Some embodiments of the disclosure provide a method. The method includes coupling, by a tool interface of the adapter, the adapter to a first power tool device; coupling, by a pack interface of the adapter, the adapter to a power tool battery pack; receiving, by an electronic controller of the adapter, sensor data from one or more sensors of the adapter; detecting, by the electronic controller, an auto-stop condition based on the sensor data; and controlling, by the electronic controller, the power tool to cease operation in response to detecting the auto-stop condition.

Some embodiments of the disclosure provide an adapter for a power tool. The adapter includes an adapter housing; a tool interface supported by the adapter housing and configured to couple to a first power tool device; a pack interface supported by the adapter housing and configured to couple to a power tool battery pack, the pack interface being in electrical communication with the first interface; one or more sensors to generate sensor data, the sensor data including an electrical characteristic of the power tool battery pack; a runtime display; and an electronic controller supported by the housing and coupled to the tool interface, the pack interface, the one or more sensors, and the runtime display, the electronic controller configured to: receive the sensor data from the one or more sensors, and determine, based on the sensor data, a runtime remaining estimate indicating a numerical amount of time to operate the power tool before the power tool battery pack reaches a discharge threshold; control a runtime display of the adapter to display the runtime remaining estimate.

Some embodiments of the disclosure provide a method. The method includes coupling, by a tool interface of the adapter, the adapter to a first power tool device; coupling, by a pack interface of the adapter, the adapter to a power tool battery pack; receiving, by an electronic controller of the adapter, sensor data from one or more sensors of the adapter; determining, based on the sensor data, a runtime remaining estimate indicating a numerical amount of time to operate the power tool before the power tool battery pack reaches a discharge threshold; and controlling, by the electronic controller, a runtime display of the adapter to display the runtime remaining estimate.

Some embodiments of the disclosure provide an adapter for a power tool. The adapter includes an adapter housing; a tool interface supported by the adapter housing and configured to couple to a first power tool device; a pack interface supported by the adapter housing and configured to couple to a power tool battery pack, the pack interface being in electrical communication with the first interface; a positive direct current (DC) lead coupling the tool interface to the pack interface; a negative DC lead coupling the tool interface to the pack interface; and a least one capacitor coupled across the positive DC lead and the negative DC lead.

Some embodiments of the disclosure provide a method. The method includes coupling, by a tool interface supported by an adapter housing, to a first power tool device; coupling, by a pack interface supported by the adapter housing, to a power tool battery pack, wherein a positive direct current (DC) lead couples the tool interface to the pack interface, and a negative DC lead couples the tool interface to the pack interface; pre-charging, by at least one capacitor coupled across the positive DC lead and the negative DC lead, to store voltage upon connection of the pack interface to the power tool battery pack and before an operation of the power tool; and discharging, by the at least one capacitor, during an operation of the power tool to supplement power provided from the power tool battery pack to the power tool.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1A illustrates an example power tool system including a power tool pack adapter coupled between a power tool and a battery pack.

FIG. 1B illustrates another view of an example power tool system including a power tool pack adapter coupled between a power tool and a battery pack.

FIG. 1C illustrates another view of an example power tool system including a power tool pack adapter, a power tool, and a battery pack that are uncoupled.

FIG. 2A shows a perspective view of an example power tool pack adapter.

FIG. 2B shows a side view of an example power tool pack adapter.

FIG. 3 shows another example of a power tool system including a power tool pack adapter having stem and sleeve interfaces.

FIG. 4A illustrates a grinder as another example of a power tool that may be included in a power tool system according to some embodiments described in the present disclosure.

FIG. 4B illustrates a circular saw as another example of a power tool that may be included in a power tool system according to some embodiments described in the present disclosure.

FIG. 4C illustrates a top handle chainsaw as another example of a power tool that may be included in a power tool system according to some embodiments described in the present disclosure.

FIG. 5 is a block diagram of an example power tool pack adapter according to some embodiments described in the present disclosure.

FIG. 6 shows a flowchart of a process for controlling a power tool based on an auto-stop condition, according to some examples.

FIG. 7 illustrates a training technique for training a machine learning model using post-operation user feedback, according to some examples.

FIG. 8 illustrates a training technique for training a machine learning model using self-supervised training, according to some examples.

FIG. 9 shows a flowchart of a process for an adapter to display a runtime remaining estimate, according to some examples.

FIG. 10 shows a flow diagram that illustrates an example technique for an adapter to generate a runtime remaining estimate, according to some examples.

FIG. 11 shows a flowchart of a process for an adapter to supplement battery pack power, according to some examples.

FIG. 12 shows a plot 1200 of a voltage and current of a battery pack experiencing an undervoltage collapse and avoiding an undervoltage collapse, according to some examples.

### DETAILED DESCRIPTION

Power tools can be used for various applications in various environments. Power tools may have a static and/or predetermined set of general functions to appeal to a wide variety of users, to apply to a wide variety of use cases, and to make their design less complex, less expensive, and smaller in size and/or weight. Power tools incorporating specific features that are desired by only select users may, accordingly, be more expensive, more complex, and/or larger in size and/or weight, or may be simply not manufactured because of one or more of these issues renders such power tools less economical. Further, power tools may remain in service for years and be unable to be upgraded with new features developed or desired by a user after an initial purchase.

Battery-powered power tools provide increased mobility and flexibility to users relative to corded power tools. Battery packs of various capacities and power output capability have been developed to accommodate different use case and power tools. Certain power tools and/or tasks may require higher current or power demands than certain battery packs are capable of providing, and result in malfunction or protection actions (e.g., shutdown of the power tool and/or battery pack).

In some embodiments provided herein, a power tool pack adapter can be coupled between a power tool and a power tool battery pack to address one or more of the aforementioned issues and provide other advantages. For example, a power tool pack adapter (also referred to herein simply as an adapter) may incorporate additional functionality for the power tool and/or battery pack. For example, in some examples, the adapter incorporates an auto-stop feature in which the adapter detects an auto-stop condition and controls the power tool to cease operation. In other examples, additionally or alternatively, the adapter incorporates a runtime display and calculates and displays a runtime remaining estimate on the runtime display. In some examples, additionally or alternatively, the power tool includes one or more capacitors that can be pre-charged by a power tool battery pack coupled to the adapter and can be discharged during a power tool operation to provide supplementary power to supplement power from the battery pack.

The adapters described in the present disclosure are backwards compatible with a variety of different power tools, battery packs, and other power tool devices. The power tool pack adapter fits between a power tool and a battery pack (or other such power tool devices) and provides extra functionality to a power tool or other power tool device that was not originally equipped with it. Additionally, a user can have a single adapter for many tools, thereby providing a cost effective solution for adding functionality without the user having to purchase new power tool devices. Further, for the additional functions that involve processing of information (e.g., auto-feature(s) and/or runtime remaining feature), such processing can be performed by an electronic controller of the adapter, rather than the power tool, freeing up processing bandwidth of an electronic controller of the power tool for other services and tasks and/or enabling use of a smaller, cheaper, and/or less complex electronic controller for the power tool.

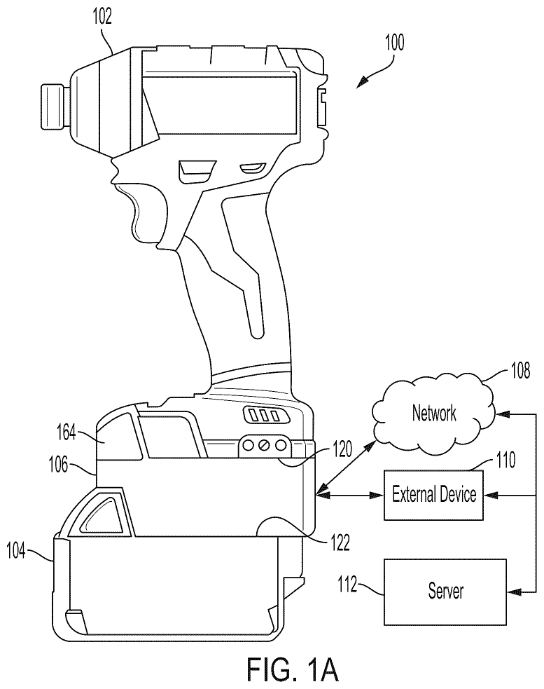

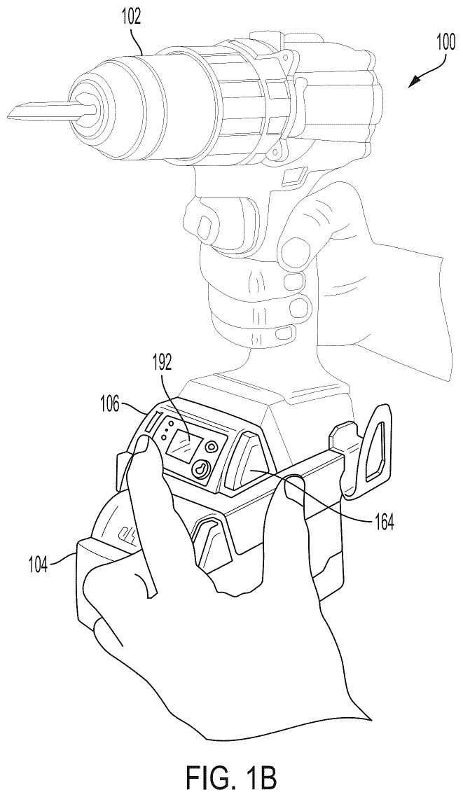

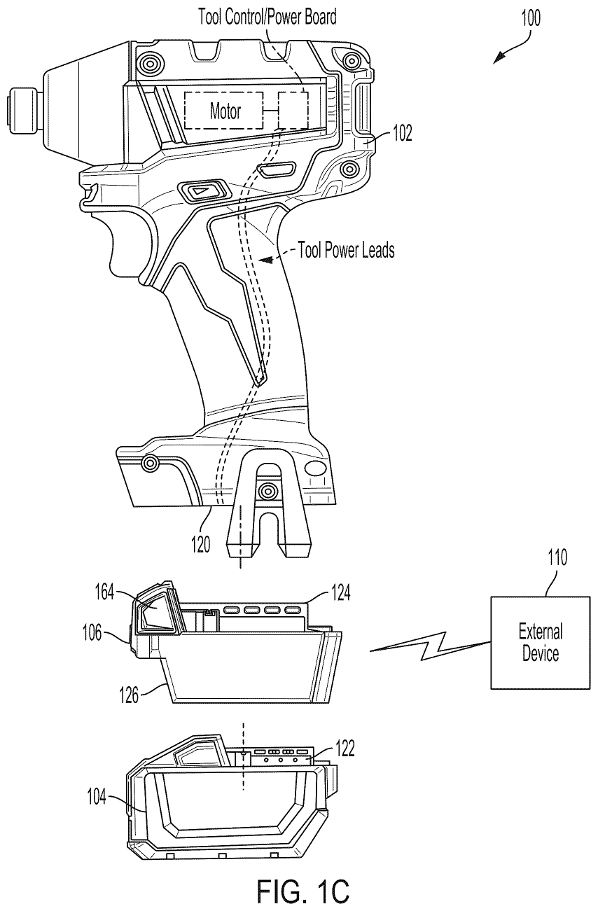

FIGS. 1A, 1B, and 1C illustrate a power tool system 100 in accordance with some embodiments. In the illustrated example, the power tool system 100 includes a power tool 102, a power tool battery pack 104, and a power tool pack adapter 106. In some configurations the power tool system 100 can also include one or more of a network 108, an external device 110, and a server 112.

The power tool pack adapter 106 is used to provide additional functionality to the power tool 102, which may include, among other things, auto-stop feature(s), a runtime remaining feature, supplemental power, and the like. The power tool system 100 may include more or fewer components than those illustrated in FIG. 1 and may perform functions other than those described herein. In some examples, the power tool pack adapter 106 may communicate with the external device 110 and/or the server 112 directly or via the network 108 to, for example, be configured for operation, as explained in further detail below.

The power tool 102 is illustrated in FIGS. 1A and 1C as an impact driver. However, the power tool 102 is any motorized or non-motorized power tool device, for example, a drill-driver, a hammer drill, a rotary hammer, a miter saw, a jigsaw, a work light, a work radio, a vacuum, a dust extractor, portable power supply, and the like. For example, in FIG. 1B, the power tool 102 is illustrated as a hammer drill-driver.

The power tool battery pack 104, also referred to as the battery pack 104, is any suitable battery pack used to power the power tool 102. The battery pack 104 can include one or more battery cells of various chemistries, such as lithium-ion (Li-Ion), nickel cadmium (Ni-Cad), etc. The battery pack 104 may have a nominal voltage of approximately 12 volts (between 8 volts and 16 volts), approximately 18 volts (between 16 volts and 22 volts), approximately 72 volts (between 60 volts and 90 volts), or another suitable amount. In the illustrated example, the battery pack 104 has a nominal voltage of 18 V. The battery pack 104 can further include a pack electronic controller (pack controller) including a processor and a memory. The pack controller can be configured to regulate charging and discharging of the battery cells.

The power tool 102 includes a first interface 120 that is configured to couple to a second interface 122 of the battery pack 104. Particularly, the power tool 102 can receive the second interface 122 of the battery pack 104 in the first interface 120 of the power tool 102.

The power tool pack adapter 106 is an adapter that is configured to be coupled between the power tool 102 and the battery pack 104, as shown in FIGS. 1A-1B. The power tool pack adapter 106 includes a tool interface 124 on a top surface of the power tool pack adapter 106 and a pack interface 126 on a bottom surface of the power tool pack adapter 106. The tool interface 124 is similar to the second interface 122 of the battery pack 104. The tool interface 124 is received in the first interface 120 of the power tool 102 to couple the power tool pack adapter 106 to the power tool 102. The pack interface 126 is similar to the first interface 120 of the power tool 102. The pack interface 126 receives the second interface 122 of the battery pack 104 to couple the power tool pack adapter 106 to the battery pack 104. Accordingly, the power tool pack adapter 106 is coupled between the power tool 102 and the battery pack 104 by coupling the first interface 120 to the tool interface 124 and coupling the second interface 122 to the pack interface 126.

Each of the interfaces 120, 122, 124, and 126 may include one or both of electrical and mechanical interfacing elements. For example, electrical interfacing elements may include electrical terminals or contacts of one interface that are configured to mate or otherwise contact electrical terminals or contacts of another interface. Additionally, for example, mechanical interfacing elements may include structures (e.g., rail and groove elements) that are configured to physically guide and secure one interface to structures of another interface.

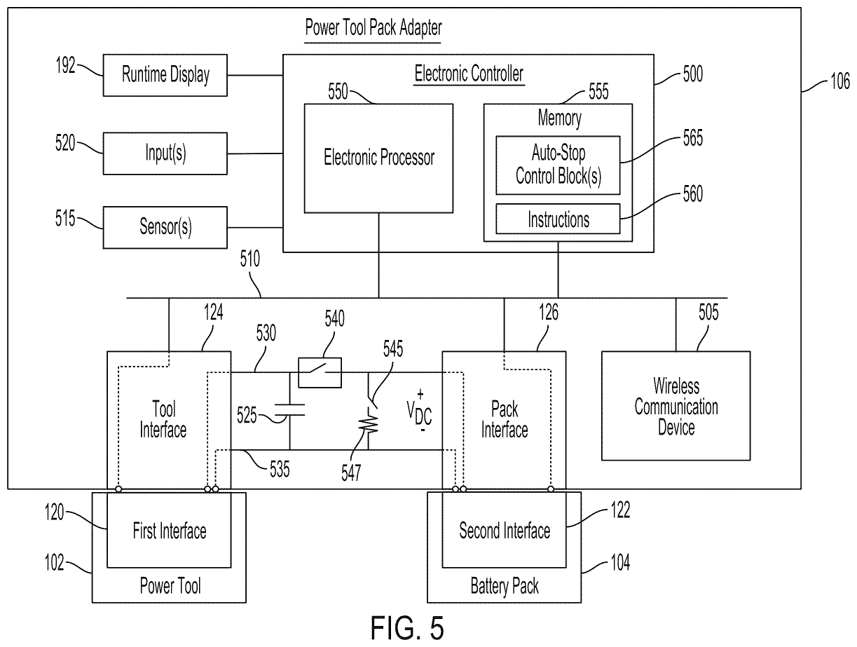

With reference to FIG. 1C, the power tool 102 may include tool power leads, a tool control/power board, and an electric motor. In some examples, the tool power leads can include one or more wires configured to provide a connection or conductive path for the power supplied by the battery pack 104, received via the first interface 120, to reach tool control/power board and electric motor of the power tool 102. The tool control/power board may include a tool control board and a power board that are separate from one another, or may include a combined tool control and power board (as shown in FIG. 1C). However, the tool control board and power board will be described as separate components. The tool power leads may connect the battery pack 104 via the first interface 120 to the tool control board and/or the power board. The tool control board can include a printed circuit board having one or more electric circuits. When a trigger button of the power tool 102 is activated, an electric signal may be provided to the tool control board/power board via the tool power leads may cause the electric motor of the power tool 102 to rotate. For example, the tool control board may include an electronic controller that is similar to the electronic controller 500 of FIG. 5, but with instructions for controlling the power tool stored in the memory and executed by the electronic processor. Further, the power board may include a switch bridge including power switching elements (e.g., field effect transistors (FETs)) that connects the electric motor to the tool power leads. The electronic controller of the tool control board may receive the signal responsive to activation of the trigger button and, in response, generate control signals for the power switching elements of the power board. The power switching elements may be selectively controlled by the control signals to, for example, provide power received via the tool power leads to the electric motor in a manner to drive the electric motor of the power tool 102 to rotate. For example, the power may be selectively provided to stator windings of the elective motor (e.g., in a cyclic pattern) to drive a permanent magnet rotor of the electric motor.

The network 108 may be a long-range wireless network such as the Internet, a local area network (“LAN”), a wide area network (“WAN”), or a combination thereof. In other embodiments, the network 108 may be a short-range wireless communication network, and in yet other embodiments, the network 108 may be a wired network using, for example, USB cables. Additionally or alternatively, the network 108 may include a combination of long-range, short-range, and/or wired connections. In some embodiments, the network 108 may include both wired and wireless devices and connections. Similarly, the server 112 may transmit information to the external device 110 to be forwarded to the power tool pack adapter 106.

In some embodiments, the power tool pack adapter 106 communicates directly with the external device 110. For example, the power tool pack adapter 106 can transmit data (e.g., identifying information that indicates an identity or type of the adapter 106 and/or of the power tool 102 and/or the battery pack 104 coupled thereto) and settings to the external device 110. Similarly, the power tool pack adapter 106 can receive data (e.g., settings, firmware updates, etc.) from the external device 110.

In some other embodiments, the power tool pack adapter 106 bypasses the external device 110 to access the network 108 and communicate with the server 112 via the network 108. In some embodiments, the power tool pack adapter 106 is equipped with a long-range transceiver instead of or in addition to a short-range transceiver. In such embodiments, the power tool pack adapter 106 communicates directly with the server 112 or with the server 112 via the network 108 (in either case, bypassing the external device 110). In some embodiments, the power tool pack adapter 106 may communicate directly with both the server 112 and the external device 110. In such embodiments, the external device 110 may, for example, generate a graphical user interface to facilitate control and programming of the power tool 102, the battery pack 104, and/or the power tool pack adapter 106, while the server 112 may store and analyze larger amounts of operational data for future programming or operation of the power tool 102, the battery pack 104, and/or the power tool pack adapter 106. In other embodiments, however, the power tool pack adapter 106 may communicate directly with the server 112 without utilizing a short-range communication protocol with the external device 110.

In the illustrated embodiment, the power tool pack adapter 106 may communicate with the external device 110. The external device 110 may include, for example, a smartphone, a tablet computer, a cellular phone, a laptop computer, a smart watch, and the like. In some embodiments, the external device 110 may include a short-range transceiver to communicate with the power tool pack adapter 106, and a long-range transceiver to communicate with the server 112. In the illustrated embodiment, power tool pack adapter 106 can also include a transceiver to communicate with the external device 110 via, for example, a short-range communication protocol such as Bluetooth® or Wi-Fi®. In some embodiments, the external device 110 bridges the communication between power tool pack adapter 106 and the server 112. For example, power tool pack adapter 106 may transmit data to the external device 110, and the external device 110 may forward the data from power tool pack adapter 106 to the server 112 over the network 108.

The server 112 includes a server electronic control assembly having a server electronic processor, a server memory, and a transceiver. The transceiver allows the server 112 to communicate with power tool pack adapter 106, the external device 110, or both. Although illustrated as a single device, the server 112 may be a distributed device in which the server electronic processor and server memory are distributed among two or more units that are communicatively coupled (e.g., via the network 108).

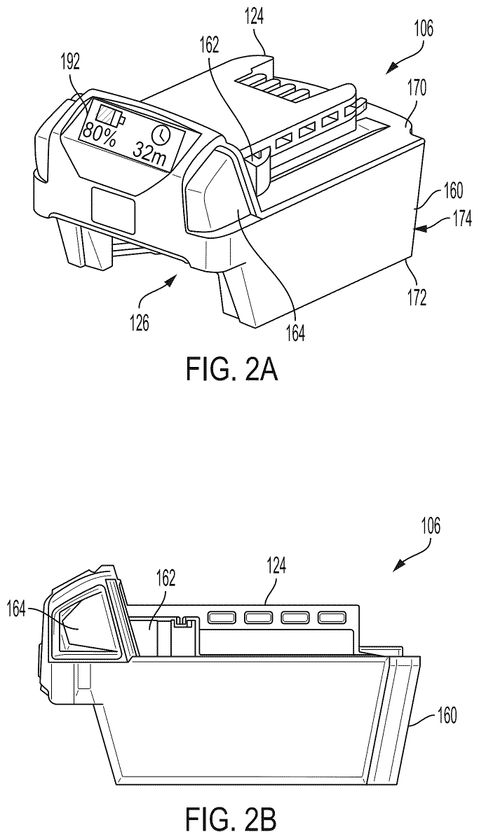

FIGS. 2A-2B illustrate additional views of the adapter 106 separated from the power tool 102 and the battery pack 104. The power tool pack adapter 106 includes a housing 160, which may be an integrally formed housing or may be composed of two or more housing parts (e.g., a first and second half-housing) that are joined or otherwise coupled together. The housing 160 includes a top side 170, a bottom side 172, and one or more sidewalls 174 connecting the top side 170 and the bottom side 172. The tool interface 124 is provided on the top side 170 of the housing 160 and the pack interface 126 is provided on a bottom side 172 of the housing 160.

The power tool pack adapter 106 includes a latch 162 provided on each of the left and right sides of the tool interface 124. Each of the latches 162 engages a corresponding projection on the first interface 120 of the power tool 102 to prevent the power tool pack adapter 106 from sliding off the power tool 102 when the power tool pack adapter 106 is coupled to the power tool 102. The latches 162 can be actuated by push buttons 164. For example, the push buttons 164 may be integrally connected, respectively, to the latches 162 inside the housing 160 such that the latches 162 move inward when the respective push button 164 is pressed to release the power tool pack adapter 106 from the power tool 102. In some examples, the push buttons 164 and the latches 162 can be spring-biased outward.

As shown in FIG. 2A (as well as FIG. 1B), the adapter 106 may include an information display 192, also referred to as a runtime display 192. As described in further detail below, the runtime display 192 may display a runtime remaining estimate for the power tool 102 and the battery pack 104 coupled to the adapter 106 before the battery pack 104 is discharged (e.g., reaches a low voltage cut-off threshold or has a state of charge below a low threshold). As shown in FIG. 2A, the runtime display 192 may display additional information as well, such as, for example, a battery state of charge (e.g., as a fuel gauge) of the battery pack 104 coupled to the adapter 106. With reference to FIG. 2A, the runtime display 192 displays a runtime remaining estimate of 32 minutes and a state of charge of 80% (of the capacity of the battery pack 104). This information displayed on the runtime display 192 corresponds to the power tool 102 and/or the battery pack 104 that may be coupled to the adapter 106 at a particular moment (e.g., as shown in FIGS. 1A-1B), although these components are not shown in FIG. 2A to simplify the illustration.

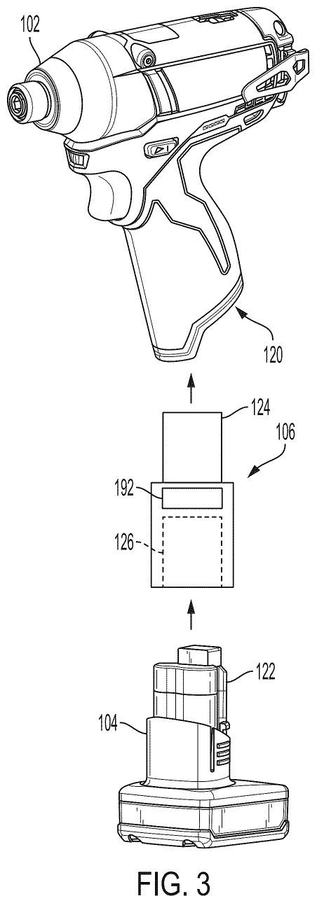

FIG. 3 illustrate an example of the adapter 106 having stem and sleeve-type interfaces. More particularly, while the interfaces 120, 122, 124, 126 of the adapters 106 in FIGS. 1A-2B are shown as engaging with power tool devices that have rail and groove interfaces for lateral sliding engagement, in other embodiments, the adapter 106 may have interfacing elements for power tool devices that involve insertion into an effective pocket or act as a sleeve, such as those illustrated in FIG. 3. More particularly, in FIG. 3, the power tool 104 has a stem-type interface as the second interface 122 that is configured to be inserted into a sleeve-type interface as the first interface 120. Accordingly, the adapter 106 in FIG. 3 similarly has a tool interface 124 that is a stem-type interface, and has a pack interface 126 that is a sleeve-type interface.

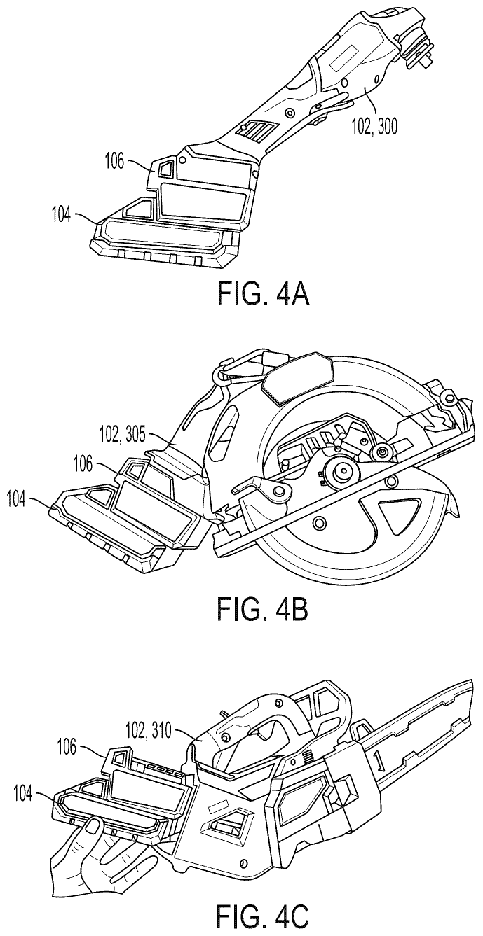

As noted above, the power tool 102 described herein (see, e.g., FIG. 1A-C) is any motorized or non-motorized power tool device, for example, a drill-driver, a hammer drill, a rotary hammer, a miter saw, a jigsaw, a work light, a work radio, a vacuum, a dust extractor, portable power supply, and the like. FIG. 4A-4C illustrate three other types of power tools that may serve as the power tool 102 and may be coupled to the adapter 106. More particularly, FIG. 4A illustrates a grinder 300, FIG. 4B illustrates a circular saw 305, and FIG. 4C illustrates a top handle chainsaw 310.

FIG. 5 illustrates a block diagram of an example power tool pack adapter 106. The adapter 106 includes the tool interface 124, the pack interface 126, and the runtime display 192 previously introduced. Additionally, the adapter 106 includes an electronic controller 500, a wireless communication device 505, a device communication bus 510, and one or more sensor(s) 515, one or more input(s) 520, and one or more capacitor(s) 525. The tool interface 124 and the pack interface are coupled by direct current (DC) leads (or wires) including a positive DC lead 530 and a negative DC lead 535. The positive DC lead 530 may be coupled to a positive terminal of the battery pack 104 and the negative DC lead 535 may be coupled to a negative terminal of the battery pack 104. The DC leads 530, 535 may provide a connection or conductive path for power supplied by the battery pack 104 to reach the power tool 102. The capacitor(s) 525 are coupled across the positive DC lead 530 and the negative DC lead 535.

In some examples, the adapter 106 may further include a disconnect switch 540 coupled along the positive DC lead 530 or the negative DC lead 535 configured to make or break a connection between the tool interface 124 and the pack interface 126 (and, thus, between the battery pack 104 and the power tool 102). In some examples, the adapter 106 may further include a discharge switch 545 and discharge resistor 547 coupled across the positive DC lead 530 and the negative DC lead 535. When enabled (or closed), the discharge switch 545 may short the DC leads 530 and 535 such that power stored on the capacitor(s) 525 is dissipated through the discharge resistor 547. Accordingly, the capacitor(s) 525 may be sized relatively large (e.g., larger than typically used for mere filtering power signal noise) to store sufficient charge to provide an impactful amount of supplement power to the power tool 102. For example, the capacitor(s) 525 may have a capacitance of between 0.1 to 10 farads (F). In some examples, the capacitor(s) 525 may be a capacitance of greater than 0.1 F, greater than 0.25 F, greater than 0.5 F, greater than 1.0 F, greater than 5.0 F, between 0.25 F and 10.0 F, between 0.5 F and 10.0 F, between 1.0 F and 10.0 F, between 2.0 F and 10.0 F, between 1.0 F and 5.0 F, between 0.1 F and 1.0 F, or between 0.5 F and 2.5 F. In some examples, the capacitor(s) 525 may be referred to as supercapacitors.

In some embodiments, the power tool pack adapter 106 may not include one or more of the electronic controller 500, the wireless communication device 505, the runtime display 192, the sensor(s) 515, the input(s) 520, the capacitor(s) 525, the disconnect switch 540, the discharge switch 545, and/or the discharge resistor 547.

The electronic controller 500 can include an electronic processor 550 and memory 555. The electronic processor 550, the memory 555, and other components of the adapter 106 illustrated in FIG. 5 can communicate over one or more control buses, data buses, etc., which can include a device communication bus 510.

The electronic processor 550 can be configured to communicate with the memory 555 to store data and retrieve stored data. The electronic processor 550 can be configured to receive instructions 560 and data from the memory 555 and execute, among other things, the instructions 560. In particular, the electronic processor 550 executes instructions 560 stored in the memory 555. Thus, the electronic controller 500 coupled with the electronic processor 550 and the memory 555 can be configured to perform at least portions or aspects of the methods described herein (e.g., portions or aspects of the processes 600, 900, and portions of 1100). The electronic processor may further retrieve one or more auto-stop control block(s) 565, which may include one or more instructions, threshold, control algorithms, and/or trained machine learning models, and execute the one or more auto-stop control block(s) 565 to implement an auto-stop control function, as described in further detail below. In some examples, the electronic processor 550 may update or train the one or more auto-stop control block(s) 565, based on user feedback received via the input(s) 520, self-supervised training, or pre-operation user demonstration training.

The memory 555 can include read-only memory (“ROM”), random access memory (“RAM”), other non-transitory computer-readable media, or a combination thereof. The memory 555 can include and store the instructions 560 and/or the auto-stop control block(s) 565 for the electronic processor 550 to execute. The instructions 560 can include software executable by the electronic processor 550 to enable the electronic controller 500 to, among other things, receive data and/or commands, transmit data, control operation of a connected power tool device, and the like. The software can include, for example, firmware, one or more applications, program data, filters, rules, one or more program modules, and other executable instructions.

The auto-stop control block(s) 565 may include one or more instructions, control algorithms, trained machine learning models, thresholds, and the like to enable the electronic processor 550 to implement an auto-stop control function, as described in further detail below. For example, each auto-stop control block of the auto-stop control block(s) 565 may be configured to detect (e.g., when executed or applied by the electronic processor 550) a particular auto-stop condition. For example, the electronic controller 500 may retrieve and execute one or more of the auto-stop control block(s) 565 to process the sensor data, and execution of each respective auto-stop control block may be generate an indication of whether the particular auto-stop condition corresponding to the auto-stop control block is present. Example auto-stop conditions detected using corresponding auto-stop control blocks of the auto-stop control block(s) 565 a kickback event, a battery overtemperature condition, completion of a saw cutting operation in which a saw has cut through a workpiece, completion of a screw fastening operation in which a screw has been seating, or completion of a tightening operation in which a tightening torque has been reached. The latter three examples (completed saw cutting, completed screw fastening, and completed tightening operation) may also be referred to as a completed tool operation.

In some examples, each auto-stop control block of the auto-stop control block(s) 565 may have a corresponding status indicating whether the particular auto-stop control block is enabled or disabled. When the status of an auto-stop control block of the auto-stop control block(s) 565 is set to enabled, the electronic processor 550 may execute the auto-stop control block to process the sensor data and determine whether the corresponding auto-stop condition is present. When the status of an auto-stop control block of the auto-stop control block(s) 565 is set to disabled, the electronic processor 550 may bypass (not execute) the auto-stop control block to process the sensor data and determine whether the corresponding auto-stop condition is present. Accordingly, as an example with four auto-stop control blocks 565, if three out of four of the auto-stop control block(s) 565 have a status set to enabled, the electronic processor 550 may execute the three auto-stop control blocks having the status sent to enabled to process the sensor data and determine whether the three corresponding auto-stop conditions are present, while the fourth auto-stop control block may be bypassed. Further, the electronic controller 500 may receive configuration data from an external device (see external device 110 of FIG. 1) that indicates whether the status of each auto-stop control block 565 should be set to enabled or disabled, and the electronic controller 500 may, in response, set the status of each auto-stop control block 565 to have the indicated status. Thus, a user may enable or disable each auto-stop control block of the auto-stop control block(s) 565 as desired by the user via the external device 110. In other examples, the auto-stop control block(s) 565 are hard-coded to be enabled and not modifiable by a user. In some examples, the adapter 106 may be dedicated to detecting and responding to one auto-stop condition and the auto-stop control block(s) 565 may include only one auto-stop control block.

The auto-stop control block(s) 565 may take different forms and/or be provided in different combinations for different examples of the adapter 106. In some examples, one or more of the auto-stop control block(s) 565 includes one or more threshold(s) and corresponding instructions to, for example, cause the electronic processor 550 to compare sensor data from the sensor(s) 515 to the one or more threshold(s). For example, a current or power threshold may be used to indicate an auto-stop condition related to screw seating, saw/cutting completion, and/or torque applied, or an rotational displacement, velocity, and/or acceleration threshold may be used to indicate an auto-stop condition related to kickback. In some examples, one or more of the auto-stop control block(s) 565 includes a trained machine learning model.

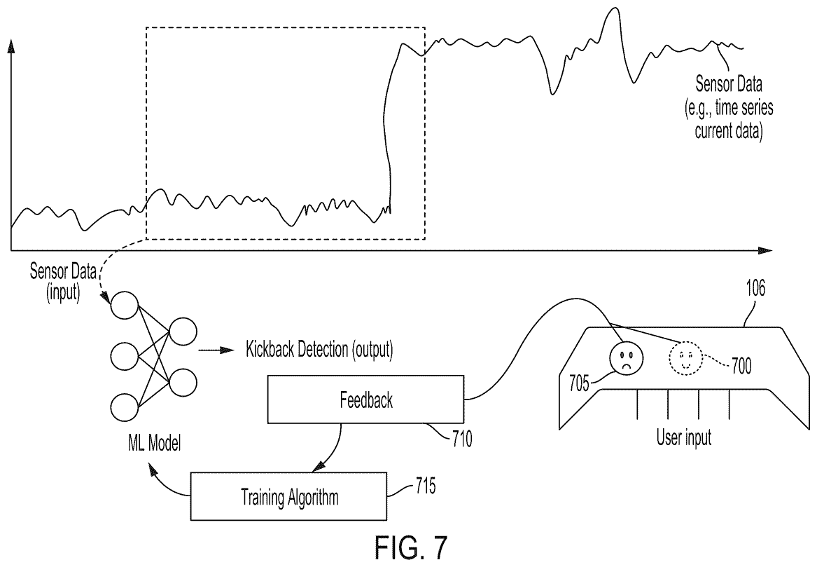

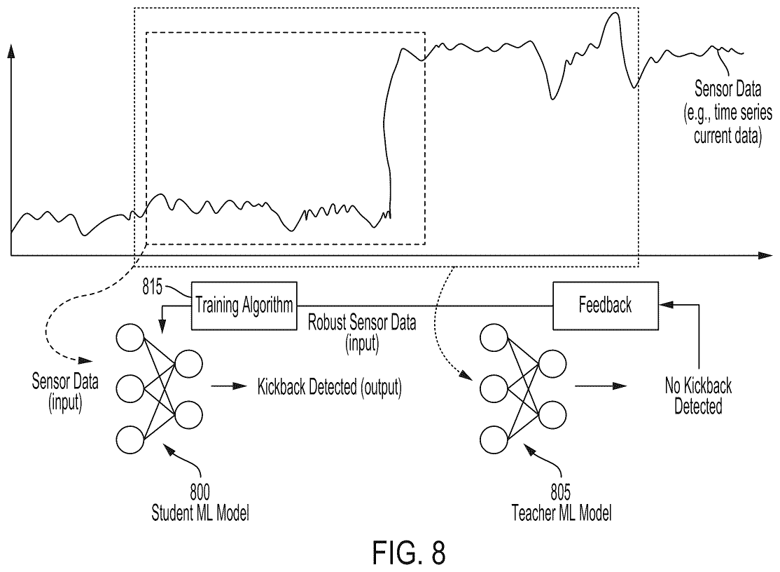

A trained machine learning model included in an auto-stop control block of the auto-stop control block(s) 565 may take various forms. For example, each such trained machine learning model may be or include a neural network model (e.g., a recursive neural network (RNN), a convolutional neural network (CNN), etc.), a naïve bayes model, a nearest neighbor model, a discriminant analysis model, a linear regression model, a generalized linear model (GLM) model, a Gaussian process model, a support vector machine (SVM) model, a decision tree model, or the like. The trained machine learning model may be constructed and trained in advance of deployment in the adapter 106. For example, in a manufacturing or programming stage, the trained machine learning model may be trained based on example inputs, which may be done using supervised learning, unsupervised learning, reinforcement learning, ensemble learning, active learning, transfer learning, or other suitable learning techniques for machine learning programs, algorithms, or models. For example, for supervised training, a training data set may be constructed that includes a plurality of sets of sensor data (e.g., each similar to sensor data that would be provided by the sensor(s) 515 during an operation) and a ground truth indicating whether an particular auto-stop condition was present for each set of sensor data. This training data may then be used to train a machine learning model (e.g., using known or existing training techniques) to generate a trained machine learning model that can receive new input and generate an indication of whether an auto-stop condition is present. Additionally or alternatively, as described further below, the trained machine learning model may be trained, at least in part, while in the field (see, e.g., discussion with respect to FIGS. 7 and 8). During execution of an auto-stop control block that includes a trained machine learning model, the electronic controller 500 may be configured to provide input data, obtained or derived from sensor data from the sensor(s) 515, to the machine learning model; process, with the machine learning model, the input data; and receive an output from the machine learning model resulting from the processing of the input data. The output may be a binary indication of whether an auto-stop condition is present (or not), may be a value between 0 and 1 that is translated by the electronic controller 500 into an indication of whether an auto-stop condition is present, or take another form.

Additionally, the electronic processor 550 can also be configured to store other data on the memory 555 including identifying information identifying the type of power tool 102, battery pack 104, or other power tool device; capacity information mapping each type of the battery pack 104 to a respective battery capacity; sensor data obtained from the sensor(s) 515, input signals received from the input(s) 520, data received via the wireless communication device 505, and other information relevant to operating or maintaining the power tool 102, battery pack 104, and/or the adapter 106.

The power tool pack adapter 106 and components thereof are configured to receive electrical power from the battery pack 104 when the battery pack 104 is coupled to the pack interface 126 of the power tool pack adapter 106.

In some embodiments, the power tool pack adapter 106 may also include a wireless communication device 505. In these embodiments, the wireless communication device 505 is coupled to the electronic controller 500 (e.g., via the device communication bus 510). The wireless communication device 505 may include, for example, a radio transceiver and antenna, a memory, and an electronic processor. In some examples, the wireless communication device 505 can further include a global navigation satellite system (“GNSS”) receiver configured to receive signals from GNSS satellites (e.g., global positioning system (“GPS”) satellites), land-based transmitters, etc. The radio transceiver and antenna operate together to send and receive wireless messages to and from the external device 110, one or more additional power tool devices, the server 112, and/or the electronic processor of the wireless communication device 505. The memory of the wireless communication device 505 stores instructions to be implemented by the electronic processor and/or may store data related to communications between the power tool pack adapter 106 and the external device 110, one or more additional power tool devices, and/or the server 112.

The electronic processor for the wireless communication device 505 controls wireless communications between the power tool pack adapter 106 and the external device 110, one or more additional power tool devices, and/or the server 112. For example, the electronic processor of the wireless communication device 505 buffers incoming and/or outgoing data, communicates with the electronic processor 550 and determines the communication protocol and/or settings to use in wireless communications.

In some embodiments, the wireless communication device 505 is a Bluetooth® controller. The Bluetooth® controller communicates with the external device 110, one or more additional power tool devices, and/or the server 112 employing the Bluetooth® protocol. In such embodiments, therefore, the external device 110, one or more additional power tool devices, and/or the server 112 and the power tool pack adapter 106 are within a communication range (i.e., in proximity) of each other while they exchange data. In other embodiments, the wireless communication device 505 communicates using other protocols (e.g., Wi-Fi, cellular protocols, a proprietary protocol, etc.) over a different type of wireless network. For example, the wireless communication device 505 may be configured to communicate via Wi-Fi through a wide area network such as the Internet or a local area network, or to communicate through a piconet (e.g., using infrared or NFC communications). The communication via the wireless communication device 505 may be encrypted to protect the data exchanged between the power tool pack adapter 106 and the external device 110, one or more additional power tool devices, and/or the server 112 from third parties.

In some embodiments, the electronic controller 500 is also connected to one or more sensor(s) 515, which may include voltage sensors or voltage sensing circuits, current sensors or current sensing circuits, inertial sensors or inertial sensing circuits (e.g., accelerometers, gyroscopes, magnetometers), or the like. The inertial sensor(s) may also be referred to as motion sensor(s). The sensor(s) 515 may output sensor data to the electronic controller 500 for processing and/or storage. The sensor data may include analog or digital signals indicative of voltage measurements (voltage data) from voltage sensor(s), of current measurements (current data) from current sensor(s), and/or of inertial measurements (motion data) from motion sensor(s). The measurements may be or include time series data of instantaneous measurements, rolling averages, or the like. The motion data may include accelerometer measurements, gyroscope measurements, and/or magnetometer measurements.

In some embodiments, the adapter 106 can include one or more input(s) 520 (e.g., one or more buttons, switches, and the like) that are coupled to the electronic controller 500 and allow a user to select a mode of the adapter 106 or provide user feedback on performance of the adapter 106 (e.g., for training or updating one or more of the auto-stop control block(s) 565). In some embodiments, the input(s) 520 includes a user interface (“UI”) element, such as an actuator, a button, a switch, a dial, a spinner wheel, a touch screen, or the like, that enable user interaction with the power tool pack adapter 106.

In some embodiments, the adapter can include the runtime display 192. The runtime display 192 may be a flat panel display, such as a liquid crystal display (“LCD”) panel, an LED display panel, an electrophoretic display panel, and the like. The flat panel display 192 can be configured to generate characters (e.g., a character display) or images to present information to a user. For example, as illustrated in FIG. 2A, the runtime display 192 can provide a battery state-of-charge of the battery pack 104 connected to the adapter 106 and a runtime remaining estimate indicating a numerical amount of time remaining (e.g., in minutes, hours, and/or seconds) to operate the power tool before the power tool battery pack 104 reaches a discharge threshold (e.g., a low state of charge threshold or low/cutoff voltage threshold at which the battery pack 104 ceases outputting power to a connected power tool 102).

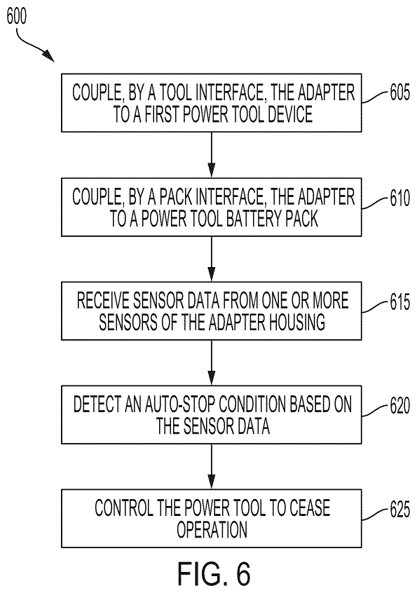

FIG. 6 shows a flowchart of a process 600 for controlling a power tool based on an auto-stop condition, according to some examples. For illustration purposes, the process 600 is generally described as being implemented by the adapter 106 in the power tool system 100 described herein and with reference to FIGS. 1A-5. However, in some embodiments, the process 600 is implemented by another adapter or system having addition components, fewer components, alternative components, etc. Although the blocks of the process 600 are illustrated in a particular order, in some embodiments, one or more of the blocks can be executed partially or entirely in parallel, can be executed in a different order than illustrated in FIG. 6, or can be bypassed.

In block 605, the process 600 includes coupling, by a tool interface of the adapter, the adapter to a first power tool device. For example, with reference to FIGS. 1A-1C, the tool interface 124 of the adapter 106 is received by and coupled to the first interface 120 of the power tool 102. This coupling may include an electro-mechanical coupling of the tool interface 124 to the first interface 120. For example, rails and grooves of the tool interface 124 and the first interface 120 may engage with one another during the coupling and the adapter 106 may be securely coupled to the power tool 102 via the latch 162. Further, DC terminals and communication terminals of the first interface 120 may engage (e.g., conductively) with DC terminals and communication terminals of the tool interface 124. Thus, with reference to FIG. 5, the positive and negative DC leads 530 and 535 may be coupled to the positive and negative terminals of the power tool 102 via the tool interface 124. Additionally, as a result of block 605, the tool power leads of the power tool 102 shown in FIG. 1C may be connected to the positive and negative DC leads 530 and 535 shown in FIG. 3 via the connection of the first interface 120 to the tool interface 124.

In block 610, the process includes coupling, by a pack interface of the adapter, the adapter to a power tool battery pack. For example, with reference to FIGS. 1A-1C, the pack interface 126 of the adapter 106 receives and is coupled to the second interface 122 of the battery pack 104. This coupling may include an electro-mechanical coupling of the pack interface 126 to the second interface 122. For example, rails and grooves of the pack interface 126 and the second interface 122 may engage with one another during the coupling and the adapter 106 may be securely coupled to the battery pack 104 via a latch of the pack (similar in form and function to the latch 162, and shown in FIG. 1C). Further, DC terminals and communication terminals of the second interface 122 may engage (e.g., conductively) with DC terminals and communication terminals of the pack interface 126. Thus, tool power leads, such as the positive and negative DC leads 530 and 535 with reference to FIG. 5, may be coupled to the positive and negative terminals of the battery pack 104 via the pack interface 126. The positive and negative terminals of the battery pack 104 may be connected to positive and negative terminals of the one or more cells of the battery pack 104.

In block 615, the process 600 includes receiving, by an electronic controller of the adapter, sensor data from one or more sensors of the adapter. For example, with reference to FIG. 5, the electronic controller 500 may receive sensor data from the sensor(s) 515. The sensor data may include one or more of current data, voltage data, and/or motion data.

In block 620, the process 600 includes detecting, by the electronic controller, an auto-stop condition based on the sensor data. For example, with reference to FIG. 5, the electronic controller 500 may detect the auto-stop condition by executing one or more of the auto-stop control block(s) 565 to process the sensor data, for example, as described above with respect to FIG. 5. The auto-stop condition may be, for example, a kickback event, a battery overtemperature condition, or a completed tool operation. The completed tool operation may be, for example, completion of a saw cutting operation in which a saw has cut through a workpiece, completion of a screw fastening operation in which a screw has been seating, or completion of a tightening operation in which a tightening torque has been reached. In some examples, to detect the auto-stop condition, the electronic processor 550 of the electronic controller 500 executes an auto-stop control block of the auto-stop control block(s) 565 that includes a trained machine learning model. In such examples, the electronic processor 550 may execute the trained machine learning model to process the sensor data from the sensor(s) 515 and receive an indication of whether the auto-stop condition is present from the trained machine learning model in response to processing the sensor data. In some examples, to detect the auto-stop condition, the electronic processor 550 of the electronic controller 500 executes an auto-stop control block of the auto-stop control block(s) 565 that includes one or more threshold(s) and related instructions. In such examples, the electronic processor 550 may execute the instructions to compare the sensor data from the sensor(s) 515 to the one or more threshold(s) and determine, in response to the comparison, whether a threshold was reached and, thus, whether the auto-stop condition is present.

In block 625, the process 600 includes generating a control signal in response to detecting the auto-stop condition. For example, with reference to FIG. 5, the control signal may be a stop signal, which the electronic controller 500 may send via the tool interface 124 to the power tool 102 that is coupled to the adapter 106. The power tool 102 (e.g., a tool controller thereof) may receive the stop signal and, in response, cease operation of the power tool 102. For example, the power tool 102 may, with the control signal, open a switch to interrupt power supply to the power tool 102, may stop generating motor driving control signals to cease driving a motor of the power tool 102, may brake a motor of the power tool 102, or otherwise may control an electronic component of the power tool 102 to cease operation or output. In another example, the electronic controller 500 may send a stop signal via the pack interface 126 to the battery pack 104 that is coupled to the adapter 106. The battery pack 104 (e.g., a pack controller thereof) may receive the stop signal and, in response, cease operation of the battery pack 104 to thereby cease operation of the power tool 102. For example, the battery pack 104 may open a switch to interrupt power supply to the power tool 102 or may itself generate a stop signal for sending to the power tool 102 to cease operation of the power tool 102. In another example, to cease operation of the power tool 102, the electronic controller 500 may control the disconnect switch 540 to open to interrupt or block power from the battery pack 104 from being delivered to the power tool 102.

In some examples of the process 600, before or as part of block 620, the electronic controller 500 determines whether an auto-stop condition is present based on the sensor data. For example, the electronic controller 500 may execute one or more of the auto-stop control block(s) 565 to process the sensor data. When the electronic controller 500 determines, based on executing the one or more auto-stop control block(s) 565, that no auto-stop condition is present, the electronic controller 500 may return to block 615 to obtain further sensor data and then proceed again to process that further sensor data to determine whether an auto-stop condition is present. When the electronic controller 500 determines that an auto-stop condition is present from processing the sensor data, the electronic controller 500 proceeds to detect an auto-stop condition based on the sensor data as described in block 620. Accordingly, the electronic controller 500 may loop through blocks 615 and 620 (e.g., repeatedly or periodically) during a tool operation until the tool operation concludes naturally (e.g., in response to a user releasing a trigger of the power tool 102, the power tool 102 ceasing operation on its own accord, or the battery pack 104 reaches a discharge threshold) or the electronic controller 500 detects an auto-stop condition.

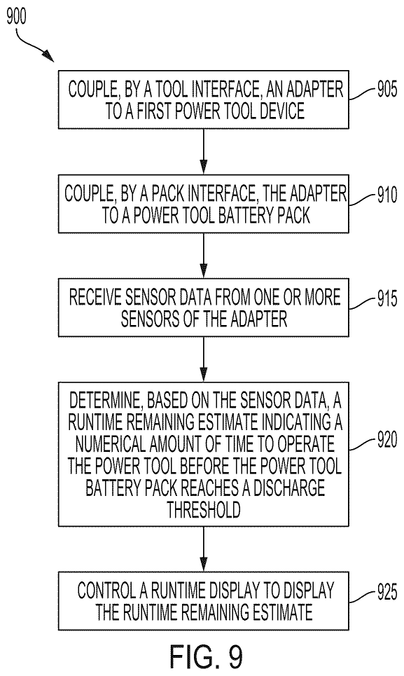

In some examples, before, during, and/or after executing the process 600, the electronic controller 500 controls the runtime display 192 to display a runtime remaining estimate indicating a numerical amount of time to operate the power tool before the power tool battery pack reaches a discharge threshold. For example, the electronic controller 500 may execute the process 900 of FIG. 9 to display the runtime remaining estimate.

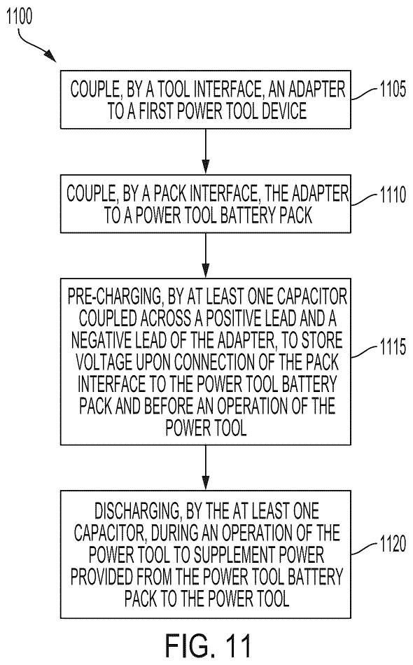

In some examples, before, during, and/or after executing the process 600, the adapter 106 supplements power from the battery pack 104 to the power tool 102 using the capacitor(s) 125 coupled across the DC leads 530, 535. For example, the adapter 106 may execute the process 1100 of FIG. 11 to supplement the power.

In some examples, before, during, and/or after executing the process 600, the electronic controller 500 receives, via a radio (wireless) transceiver of the wireless communication device 505, an auto-stop control block selection indication from the external device 110. In response, the electronic controller 500 enables one of the auto-stop control block(s) 565 in response to the auto-stop control block selection indication. For example, each auto-stop control block of the auto-stop control block(s) 565 may be enabled or disabled by the electronic controller 500. For example, the electronic controller 500 may set a respective status of each of the auto-stop control block(s) 565 to enabled or disabled based on configuration data received from the external device 110. When the electronic controller 500 receives sensor data (e.g., in block 615), the electronic controller 500 may execute each of the auto-stop control block(s) 565 that are enabled to process the sensor data to determine whether the respective auto-stop condition detectable by each of the auto-stop control block(s) 565 is present (or not present). However, the electronic controller 500 may bypass or not execute the auto-stop control block(s) 565 that have a status set to disabled. Thus, via the external device 110, a user may configure or customize the adapter 106 and specify which, if any, of the auto-stop control block(s) 565 are enabled and which, if any, of the auto-stop control block(s) 565 are disabled. Thus, for example, a user may configure the adapter 106 to perform auto-stop for detected kickback events and battery overtempt conditions, but not perform auto-stop for completion of an operation. In another example, a user may configure the adapter 106 to perform auto-stop battery overtempt conditions, but not perform auto-stop for completion of an operation or kickback events. Of course, these configurations are merely an example, and other combinations of enabled and disabled auto-stop control blocks are also possible.

In some examples, when the auto-stop control block(s) 565 include a trained machine learning model, the electronic controller may further train such trained machine learning model following a tool operation. For example, after block 625, the adapter 106 (e.g., the electronic controller 500) may receive post-operation user feedback via the input(s) 520 indicative of whether the user believed that the adapter properly detected the auto-stop condition in block 620. Additionally or alternatively, the adapter 106 (e.g., the electronic controller 500) may receive user feedback when the electronic controller 500 does not detect an auto-stop condition, but the user believes that the electronic controller 500 should have detected an auto-stop condition. The user feedback may be in the form of a binary indication of whether the adapter 106 performed well or did not perform well. For example, with reference to FIG. 7, the adapter 106 may include a performed well button 700 and a performed poorly button 705, which may be part of the input(s) 520 (see FIG. 5). Upon depression of the performed well button 700 or the performed poorly button 705, the electronic controller 500 receives a feedback signal 710 indicative of the particular button press. The electronic controller 500 may then execute a training algorithm 715 to update the trained machine learning model of the auto-stop control block(s) 565 based on the feedback (indicating good or poor performance) for the operation and the corresponding sensor data for the operation (which may have been stored in the memory 555). To update the trained machine learning model, the training algorithm 715 may update one or more weights of the model. For example, the training algorithm 715 may be a gradient descent algorithm, a logistic regression algorithm, a linear regression algorithm, or the like.

As another example, to further train the trained machine learning model, the electronic controller 500 may implement self-supervised training using a teacher model. For example, with reference to FIG. 8, the trained ML model of the auto-stop control block(s) 565 includes a student ML model 800, and the electronic controller 500 further includes a teacher ML model 805. The student ML model 800 may function as the trained machine learning model, previously described, to detect an auto-stop condition (e.g., kickback). The teacher ML model 805 may be similarly structured and similarly detect the auto-stop condition. However, the student ML model 800 may be executed in real time with a smaller, less robust set of input sensor data, while the teacher ML model 805, which may be executed after the tool operation is complete, may have access to and be able to process a more robust set of input sensor data (including a larger and/or more detailed data set). Thus, the teacher ML model 805 may be able to more accurate detect the auto-stop condition than the student ML model 800. When the outputs of the teacher ML model 805 and the student ML model 800 conflict (e.g., the student model detects an auto-stop condition and the teacher ML model 805 does not detect an auto-stop condition), the electronic controller 500 may execute a training algorithm 815 to update or train the student ML model 800. For example, to update the student ML model 800, the training algorithm 815 may update one or more weights of the student ML model 800. For example, the training algorithm 815 may be a gradient descent algorithm, a logistic regression algorithm, a linear regression algorithm, or the like. As a result, the student ML model 800 should be more likely to accurately detect an auto-stop condition based on the less robust sensor data that it receives and processes.

As another example, to further train the trained machine learning model, the electronic controller 500 may employ pre-operation user demonstration training. For example, the adapter 106 may receive a request to enter a demonstration mode (e.g., via one of the input(s) 520 or via a communication from the external device 110). In the demonstration mode, the user may operate the power tool 102 to perform an operation through completion (e.g., completing a cut of a workpiece, seating a fastener, reaching a desired torque or tightness, etc.). The electronic controller 500 may obtain sensor data from the sensor(s) 515 during the operation and may provide the sensor data to a training algorithm of the electronic controller 500 when the operation ends. The training algorithm may presume that the operation was successful and that the sensor data is indicative of a completed operation that should be detected as an auto-stop condition, and may update the trained machined learning model accordingly. For example, the electronic controller 500 may execute the training algorithm to update or train the trained machine learning model based on the sensor data. For example, to update the trained machine learning model, the training algorithm may update one or more weights of the trained machine learning model. For example, the training algorithm may be a gradient descent algorithm, a logistic regression algorithm, a linear regression algorithm, or the like.

FIG. 9 shows a flowchart of a process 900 for an adapter to display a runtime remaining estimate, according to some examples. For illustration purposes, the process 900 is generally described as being implemented by the adapter 106 in the power tool system 100 described herein and with reference to FIGS. 1A-5. However, in some embodiments, the process 900 is implemented by another adapter or system having addition components, fewer components, alternative components, etc. Although the blocks of the process 900 are illustrated in a particular order, in some embodiments, one or more of the blocks can be executed partially or entirely in parallel, can be executed in a different order than illustrated in FIG. 9, or can be bypassed.

In block 905, the process 900 includes coupling, by a tool interface of the adapter, the adapter to a first power tool device. Block 905 may be implemented similarly to block 605 of FIG. 6 and, accordingly, the discussion above with respect to block 605 similarly applies to block 905. For example, with reference to FIGS. 1A-1C, the tool interface 124 of the adapter 106 may be received by and coupled to the first interface 120 of the power tool 102.

In block 910, the process 900 includes coupling, by a pack interface of the adapter, the adapter to a power tool battery pack. Block 910 may be implemented similarly to block 610 of FIG. 6 and, accordingly, the discussion above with respect to block 610 similarly applies to block 910. For example, with reference to FIGS. 1A-1C, the pack interface 126 of the adapter 106 may be received by and coupled to the second interface 122 of the battery pack 104.

In block 915, the process 900 includes receiving, by an electronic controller of the adapter, sensor data from one or more sensors of the adapter. For example, with reference to FIG. 5, the electronic controller 500 may receive sensor data from the sensor(s) 515. The sensor data may include current data and/or voltage data for the battery pack 104 coupled to the adapter 106. For example, the current data and/or voltage data may be time-series data and include a plurality of instantaneous current and/or voltage measurements over time. The voltage measurements may be taken across DC terminals of the battery pack 104 at the pack interface 126 (e.g., across DC leads 530, 535). The current measurements may be taken at the positive DC terminal or negative DC terminal of the battery pack 104 (e.g., along the positive DC lead 530 or along the negative DC lead 535).

In some examples, in block 915, the electronic controller 500 also determines a pack type of the battery pack 104 coupled to the adapter 106. For example, the electronic controller 500 may receive a pack identifier from the battery pack 104 over the pack interface and via the bus 510, where the pack identifier identifies the pack type of the battery pack 104. In other examples, the electronic controller 500 may deduce the pack type based on a voltage or current signature of the battery pack 104.

In block 920, the process 900 includes determining, based on the sensor data, a runtime remaining estimate indicating a numerical amount of time to operate the power tool before the power tool battery pack reaches a discharge threshold. For example, the electronic controller 500 may perform intermediate processing to determine from the sensor data and the pack type, a nominal capacity, state of charge, state of health, and average current for the battery pack 104. The electronic controller 500 may then calculate the runtime remaining estimate by combining the nominal capacity, the state of health, the state of charge, and the average current draw. For example, the electronic controller 500 may use the following equation to calculate the runtime remaining estimate:

$$Runtime = \frac{Nominal Capacity * State of Health * State of Charge}{Average Current Draw}$$

To determine the nominal capacity, the electronic controller 500 may access a lookup table or database in the memory 555 that maps pack types to a respective nominal capacity associated with each pack type. Accordingly, the electronic controller 500 may determine a nominal capacity of the battery pack 104 coupled to the adapter 106 by providing the pack type as an input to the lookup table or database and receiving the nominal capacity in return. The electronic controller 500 may determine the average current draw by taking a set of N instantaneous current measurements of the sensor data (e.g., the most recent N measurements) and dividing by N, where N is an integer greater than two. The state of charge of the battery pack 104 is a value between 0 and 1 (sometimes expressed as a percentage) that represents the current charge level that the battery pack 104 has relative to the maximum charge level that the battery pack 104 can currently achieve. The electronic controller 500 may determine the state of charge of the battery pack 104 by accessing a state of charge (SOC) lookup table, which maps a voltage to a state of charge, with the most recent voltage measurement or an average voltage (e.g., of voltage measurements over the previous 5, 10, or M measurements) to receive a state of charge in return. The state of health of the battery pack 104 is a value between 0 and 1 (sometimes expressed as a percentage) represents the maximum charge level that the battery pack 104 can currently achieve relative to the rated maximum charge level that the battery pack 104. The electronic controller 500 may determine the state of health of the battery pack 104 by sensing a voltage of the battery pack 104 upon initial connection (e.g., presuming it to be at a fully charged state or in response to an indication from the battery pack 104 that the pack is at a fully charged state). In another example, the electronic controller 500 may determine the state of health of the battery pack 104 by determining a voltage discharge curve from voltage measurements of the sensor data overtime and matching the voltage discharge curve to state of health using a lookup table or database that maps such curves to state of health values.

In block 925, the process 900 includes controlling, by the electronic controller, a runtime display of the adapter to display the runtime remaining estimate. For example, with reference to FIG. 5, the electronic controller 500 may control the runtime display 192 to display the runtime remaining estimate. The runtime remaining estimate can indicate, numerically, an amount of time remaining (e.g., in minutes, hours, and/or seconds) to operate the power tool before the power tool battery pack 104 reaches a discharge threshold. FIG. 2A illustrates an example of the runtime display 192 displaying a runtime remaining estimate (shown as 32 minutes, in this example). In some examples, in block 925, the electronic controller 500 also controls the runtime display 192 to display other battery pack information regarding the battery pack 104, such as, for example, the state of charge (shown in FIG. 2A as 80%), the state of health, and/or the average current. The other battery pack information may be shown simultaneously with the runtime remaining estimate or sequentially (e.g., cycling among the various information).

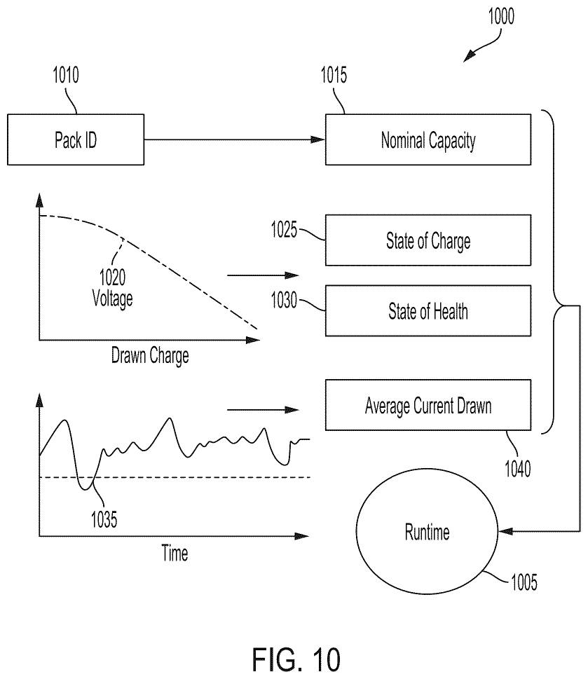

FIG. 10 shows a flow diagram 1000 that illustrates an example technique for an adapter (e.g., the adapter 106) to generate a runtime remaining estimate 1005, which may also be implemented by executing the process 900 of FIG. 9. As illustrated, the adapter 106 may use a pack identifier (ID) 1010 that identifies a pack type of the battery pack 104 to determine a nominal capacity 1015 of the battery pack 104. Further, the adapter 106 may use a voltage curve 1020 generated from voltage measurements of sensor data from the sensor(s) 515 to determine a state of charge 1025 and a state of health 1030 for the battery pack 104. Further, the adapter 106 may use a current curve 1035 generated from current measurements of sensor data from the sensor(s) 515 to determine an average current drawn 1040 for the battery pack 104. The adapter 106 may then generate the runtime remaining estimate 1005 using the nominal capacity 1015, the state of charge 1025, the state of health 1030, and the average current drawn 1040. For example, the adapter 106 may generate the runtime remaining estimate 1005 using the above-noted equation.

FIG. 11 shows a flowchart of a process 1100 for an adapter to supplement battery pack power, according to some examples. For illustration purposes, the process 1100 is generally described as being implemented by the adapter 106 in the power tool system 100 described herein and with reference to FIGS. 1A-5. However, in some embodiments, the process 1100 is implemented by another adapter or system having addition components, fewer components, alternative components, etc. Although the blocks of the process 1100 are illustrated in a particular order, in some embodiments, one or more of the blocks can be executed partially or entirely in parallel, can be executed in a different order than illustrated in FIG. 11, or can be bypassed.

In block 1105, the process 1100 includes coupling, by a tool interface of the adapter, the adapter to a first power tool device. Block 1105 may be implemented similarly to block 605 of FIG. 6 and, accordingly, the discussion above with respect to block 605 similarly applies to block 1105. For example, with reference to FIGS. 1A-1C, the tool interface 124 of the adapter 106 may be received by and coupled to the first interface 120 of the power tool 102.

In block 1110, the process 1100 includes coupling, by a pack interface of the adapter, the adapter to a power tool battery pack. Block 1110 may be implemented similarly to block 610 of FIG. 6 and, accordingly, the discussion above with respect to block 610 similarly applies to block 1110. For example, with reference to FIGS. 1A-1C, the pack interface 126 of the adapter 106 may be received by and coupled to the second interface 122 of the battery pack 104. Accordingly, with reference to FIG. 5, after the couplings of blocks 1105 and 1110, the positive DC lead 530 may couple the tool interface 124 to the pack interface 126, and the negative DC lead 535 may couple the tool interface 124 to the pack interface 126.

In block 1115, the process 1100 includes pre-charging, by at least one capacitor coupled across the positive lead and the negative lead, to store voltage upon connection of the pack interface to the power tool battery pack and before an operation of the power tool. For example, with reference to FIG. 5, the capacitor(s) 525 coupled across the DC leads 530, 535 may be pre-charged by the battery pack 104 when the battery pack 104 is coupled to the pack interface 126. The charging rate may occur at a rate corresponding to the voltage level of the battery pack 104 and a time constant of the capacitor(s) 525.

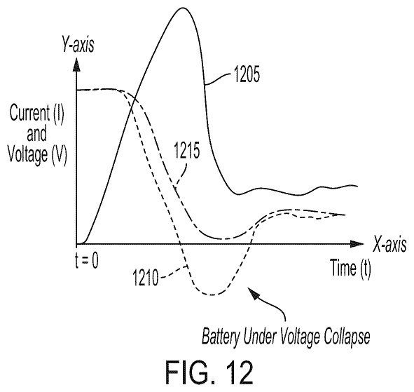

In block 1120, the process 1100 includes discharging, by the at least one capacitor, during an operation of the power tool to supplement power provided from the power tool battery pack to the power tool. For example, the power tool 102 may be actuated (e.g., in response to a trigger pull or button press) and, in response, draw power from the battery pack 104 (e.g., to power a motor or other electronics of the power tool 102). For certain battery packs with a lower maximum output power (e.g., below a certain power threshold) when used with certain power tools with a higher power demand (e.g., above the certain power threshold), a fault condition can arise referred to as a battery undervoltage condition or battery undervoltage collapse. With reference to FIG. 12, a plot 1200 illustrates this condition. In particular, plot 1200 illustrates a power tool operation starting at time t=0, current draw increasing as shown by the current curve 1205, and voltage decreasing as shown by the voltage curve 1210. When voltage crosses the x-axis, a battery undervoltage collapse is occurring. However, by discharging, by the capacitor(s) 525, during the operation of the power tool to supplement power provided by the battery pack 104 (e.g., in block 1120), the voltage curve 1215 may result and the battery undervoltage collapse may be avoided.

In some examples, after the capacitor(s) 525 are pre-charged (e.g., in block 1115), the battery pack 104 may be disconnected from the adapter 106 before an operation of the power tool 102 or otherwise when charge remains on the capacitor(s) 525. In such a scenario, in some examples, the adapter 106 discharges the capacitor(s) 525. By discharging the capacitor(s) 525 in this manner, if terminals of the adapter 106 (e.g., of the pack interface 126) are shorted, no or little charge remains on the capacitor(s) 525 that could otherwise be inadvertently discharged across the shorted terminals.

In some examples, to perform the discharge, the electronic controller 500 detects the disconnection of the battery pack 104 from the pack interface 126 of the adapter 106 (e.g., based on sensor data from the sensor(s) 515 indicating an open circuit at the battery terminals, a lack of a heartbeat signal from the battery pack 104, etc.). In response, the electronic controller 500 may control the discharge switch 545 to close. By closing the discharge switch 545, the positive DC lead 530 and the negative DC lead 535 may be shorted (through discharge resistor 547), and the capacitor(s) 525 may be discharged across the discharge resistor 547. In this example, the disconnect switch 540 may be presumed or controlled to be closed as well. In some examples, to perform the discharge, the discharge switch 545 is mechanically closed by disengagement of the battery pack 104 from the pack interface 126. For example, the discharge switch 545 may be biased closed (e.g., spring-biased), and may be opened by a projection of the battery pack 104 upon connection to the pack interface 126. Then, when the battery pack 104 is disconnected, the closed bias of the discharge switch 545 in the absence of the projection may cause the discharge switch 545 to close.

The adapter 106 may be configured to execute one, all, or any subset of the processes 600, 900, and 1100. In examples where the adapter 106 is not configured to execute one or more of these processes, features specific to that or these process(es) may not be present in the adapter 106. For example, in examples where the adapter 106 is not configured to execute the process 1100, one or more of the capacitor(s) 525, the discharge switch 545, and the discharge resistor 547 may not be present in the adapter. Similarly, in examples where the adapter 106 is not configured to execute the process 600 or 900, one or more of the electronic controller 500, wireless communication device 505, runtime display 192, input(s) 520, or sensor(s) 515 may not be present.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature can sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. An adapter for a first power tool device, comprising:
an adapter housing;
a tool interface supported by the adapter housing and configured to couple to the first power tool device;
a pack interface supported by the adapter housing and configured to couple to a power tool battery pack, the pack interface being in electrical communication with the tool interface;
one or more sensors to generate sensor data, the sensor data including an electrical characteristic of the power tool battery pack; and
an electronic controller supported by the adapter housing and coupled to the tool interface, the pack interface, and the one or more sensors, the electronic controller configured to:
receive the sensor data from the one or more sensors,
detect, based on the sensor data, an auto-stop condition, and
generate a control signal in response to detecting the auto-stop condition.

2. The adapter of claim 1, wherein the control signal is configured to control the first power tool device to cease operation in response to detecting the auto-stop condition.

3. The adapter of claim 2, wherein the auto-stop condition is at least one selected from a group of a kickback event, a battery overtemperature condition, or a completed tool operation.

4. The adapter of claim 3, wherein the auto-stop condition is a completed tool operation and the completed tool operation is at least one selected from a group of a saw cutting operation in which a saw has cut through a workpiece, a screw fastening operation in which a screw has been seating, or a tightening operation in which a tightening torque has been reached.

5. The adapter of claim 2, wherein, to control the first power tool device to cease operation, the electronic controller is configured to perform at least one selected from a group of:
send the control signal to the first power tool device, wherein the control signal is a stop signal,
send the control to the power tool battery pack, wherein the control signal is a stop signal, or
control, with the control signal, a switch in the adapter housing to open to block power from the power tool battery pack from being delivered to the first power tool device.

6. The adapter of claim 1, wherein the electrical characteristic is at least one of voltage or current, and wherein the sensor data further includes motion data sensed by a motion sensor of the one or more sensors.

7. The adapter of claim 1, further comprising:
a positive direct current (DC) lead coupling the tool interface to the pack interface;
a negative DC lead coupling the tool interface to the pack interface; and
a least one capacitor coupled across the positive DC lead and the negative DC lead.

8. The adapter of claim 7, wherein the at least one capacitor is configured to:
pre-charge to store voltage upon connection of the pack interface to the power tool battery pack and before an operation of the first power tool device; and
discharge during an operation of the first power tool device to supplement power provided from the power tool battery pack to the first power tool device.

9. The adapter of claim 1, further comprising:
a runtime display in communication with the electronic controller,
wherein the electronic controller is further configured to:
control the runtime display to display a runtime remaining estimate indicating a numerical amount of time to operate the first power tool device before the power tool battery pack reaches a discharge threshold.

10. The adapter of claim 9, wherein the electronic controller is further configured to:
determine a pack type for the power tool battery pack; and
determine the runtime remaining estimate based on the sensor data and the pack type.

11. The adapter of claim 10, wherein, to determine the runtime remaining estimate, the electronic controller is further configured to:
determine, based on the pack type and the sensor data, a state of charge of the power tool battery pack, a state of health of the power tool battery pack, and an average current for the power tool battery pack; and
calculate the runtime remaining estimate based on the state of charge of the power tool battery pack, the state of health of the power tool battery pack, and the average current for the power tool battery pack.

12. The adapter of claim 1, further comprising:
a wireless transceiver configured to wirelessly communicate with an external computing device;
a memory storing a plurality of auto-stop control blocks, each of the auto-stop control blocks configured to be executed by a processor of the electronic controller to implement a different auto-stop control;
wherein the electronic controller is further configured to:
receive, via the wireless transceiver, an auto-stop control block selection indication from the external computing device; and
enable one of the auto-stop control blocks in response to the auto-stop control block selection indication.

13. The adapter of claim 1, further comprising:
a memory storing a trained machine learning model that is trained to detect the auto-stop condition from input sensor data;
wherein, to detect the auto-stop condition, the electronic controller is further configured to:
execute the trained machine learning model to process the sensor data; and
receive an indication of the auto-stop condition from the trained machine learning model in response to processing the sensor data.

14. The adapter of claim 13, wherein the electronic controller is further configured to further train the trained machine learning model based on at least one selected from a group of: post-operation user feedback, pre-operation user demonstration training, or self-supervised training using a teacher model.

15. A method for an adapter for a first power tool device, the method comprising:
coupling, by a tool interface of the adapter, the adapter to a first power tool device;
coupling, by a pack interface of the adapter, the adapter to a power tool battery pack;
receiving, by an electronic controller of the adapter, sensor data from one or more sensors of the adapter;
detecting, by the electronic controller, an auto-stop condition based on the sensor data; and
controlling, by the electronic controller, the first power tool device using a control signal in response to detecting the auto-stop condition.

16. The method of claim 15, wherein the control signal is configured to control the first power tool device to cease operation in response to detecting the auto-stop condition.

17. The method of claim 16, wherein controlling the first power tool device to cease operation comprises performing at least one selected from a group of:
sending the control signal to the first power tool device, wherein the control signal is a stop signal,
sending the control signal to the power tool battery pack, wherein the control signal is a stop signal, or
controlling, with the control signal, a switch in the adapter housing to open to block power from the power tool battery pack from being delivered to the first power tool device.

18. The method of claim 15, wherein
a positive direct current (DC) lead couples the tool interface to the pack interface;
a negative DC lead couples the tool interface to the pack interface; and
a least one capacitor is coupled across the positive DC lead and the negative DC lead.

19. The method of claim 18, further comprising:
pre-charging the at least one capacitor to store voltage upon connection of the pack interface to the power tool battery pack and before an operation of the first power tool device; and
discharging the at least one capacitor during an operation of the first power tool device to supplement power provided from the power tool battery pack to the first power tool device.

20. The method of claim 15, wherein the adapter further includes a runtime display in communication with the electronic controller, and wherein the method further comprises:
controlling the runtime display to display a runtime remaining estimate indicating a numerical amount of time to operate the first power tool device before the power tool battery pack reaches a discharge threshold.

21-62. (canceled)
